(19) United States
(12) Patent Application Publication
(10) Pub. No.: US 2011/0271678 A1
(43) Pub. Date: Nov. 10, 2011

(54) TURBOMACHINE COMBUSTION CHAMBER WALL HAVING A SINGLE ANNULAR ROW OF INLET ORIFICES FOR PRIMARY AIR AND FOR DILUTION AIR

(75) Inventors: Sebastien Alain Christophe Bourgois, Moissy Cramayel Cedex (FR); Patrice Andre Commaret, Moissy Cramayel Cedex (FR); Thierry Andre Emmanuel Cortes, Moissy Cramayel Cedex (FR)

(73) Assignee: SNECMA, Paris (FR)

(21) Appl. No.: 13/144,794

(22) PCT Filed: Oct. 1, 2009
(86) PCT No.: PCT/FR2009/001176

§ 371 Date: Jul. 15, 2011

(30) Foreign Application Priority Data
Jan. 19, 2009 (FR) 09/00221

(51) Int. Cl. F02C 3/14

(52) U.S. Cl. 60/722

(57) ABSTRACT

A turbomachine combustion chamber including coaxial walls forming surfaces of revolution that include inlet orifices for admitting primary air and dilution air into the chamber, the orifices in each wall being substantially in alignment with one another along the longitudinal axis of the chamber and forming a single annular row of orifices.

The present invention relates to an annular combustion chamber for a turbomachine, such as an airplane turboprop or turbojet.

Such a combustion chamber has two coaxial walls forming surfaces of revolution that extend one inside the other and that are connected together at their upstream ends by an annular chamber end wall having openings with fuel injection systems mounted therein.

The inner and outer walls of the combustion chamber include air inlet orifices for admitting primary air and dilution air. In the prior art, each chamber wall includes both an annular row of primary air inlet orifices and an annular row of dilution air inlet orifices, the primary air inlet orifices being situated upstream from the dilution air inlet orifices. The air conveyed via the primary air inlet orifices serves to prevent recirculation zones occurring in the combustion chamber and to feed the chamber with air so as to ensure stoichiometric combustion of the fuel, while the air that passes through the dilution air inlet orifices of the chamber serves to control the temperature profile in the chamber by reducing the temperature of the combustion gas to a temperature that is acceptable for the turbine of the turbomachine that is mounted downstream from the chamber.

Nitrogen oxides (NOₓ) are produced in the stoichiometric combustion zone and in neighboring zones, where the richness of the air/fuel mixture lies in the range 0.7 to 1.3, and they are rejected into the atmosphere. Nitrogen oxides are produced essentially in the intermediate volume of the chamber that is situated between the row of primary air inlet orifices and the row of dilution air inlet orifices.

In order to reduce these emissions of polluting compounds, proposals have already been made for a rich quench lean (RQL) type combustion chamber having a primary combustion zone where richness is greater than stoichiometric, followed by a constriction having primary air injection holes for achieving rapid dilution. Nevertheless, that solution encourages the production of smoke in the primary zone and gives rise to problems with the high-temperature behavior of the constriction.

Another known solution consists in organizing staged combustion in a dual-head combustion chamber having two series of injection systems and two combustion zones that are optimized for low speeds and high speeds respectively. The drawbacks of that solution comprise considerable weight, high cost, and the complexity of controlling the chamber.

Another technique consists in using a multipoint chamber in which all of the primary air is introduced via the chamber end wall through the injection system so as to create a mixture that is lean at high speed and zones that are locally rich when idling (see for example document US 2004/025508 in the name of the Applicant, and document EP 1 235 032). That technique enables the formation of nitrogen oxides to be reduced but it remains complex and expensive.

Proposals have also been made to reduce the above-mentioned intermediate zone of the combustion chamber by shifting the row of dilution air inlet orifices upstream, i.e. by reducing the distance between the rows of primary air and dilution air inlet orifices. Nevertheless, that solution does not enable emissions of nitrogen oxides to be reduced sufficiently.

A particular object of the invention is to reduce the emissions of nitrogen oxides in a turbomachine combustion chamber in a manner that is simple, effective, and inexpensive.

To this end, the invention provides an annular combustion chamber for a turbomachine, such as an airplane turboprop or turbojet, the chamber comprising coaxial walls forming surfaces of revolution that include inlet orifices for admitting primary air and dilution air into the chamber, the chamber being characterized in that the primary air inlet orifices and the dilution air inlet orifices in each wall are substantially in alignment with one another around the longitudinal axis of the chamber so as to form a single annular row of orifices.

Each wall of the combustion chamber of the invention thus includes a single row of inlet orifices for admitting primary air and dilution air, as compared with two rows in the prior art. The invention thus makes it possible to eliminate the intermediate volume of the chamber (as opposed to reducing it as was the case in the prior art), and thus significantly to reduce emissions of nitrogen oxides from the chamber. It also makes it possible to reduce the cost of fabricating the walls of the chamber by eliminating the machining of one of the annular rows of orifices.

The orifices in each wall of the chamber serve simultaneously to admit primary air and dilution air into the chamber. Only a fraction of the primary air flow that passes through the primary air inlet orifices in the prior art is intended to pass through the primary air inlet orifices and the dilution air inlet orifices of the chamber. The remainder of the primary air flow serves to feed the fuel injection systems that are mounted in the end wall of the combustion chamber. The fraction of the primary air flow that passes through the orifices of the invention serves solely to prevent recirculation zones occurring in the chamber and it represents about 25% of the total primary air flow. The fraction of the primary air that passes through the injection systems of the chamber serves to feed the chamber with air and represents about 75% of the total primary air flow. The invention thus serves to separate the two above-mentioned functions that were performed in the prior art solely by the primary air inlet orifices of the chamber.

The orifices in each chamber wall are situated on a curve that is centered on the longitudinal axis of the chamber. In one embodiment, the line on which the orifices are situated is substantially circular. The orifices are then situated in a transverse plane, which plane may be perpendicular to the axis of the chamber.

In a variant, at least some of the orifices in each wall of the chamber may be situated on a line made up of circular arcs or undulations.

The chamber walls may also include multiple perforations for passing cooling air.

The inlet orifices for primary air and for dilution air in each wall are preferably regularly distributed around the longitudinal axis of the chamber.

The shape and/or dimensions of the orifices in each wall may be substantially identical, or they may be different, in particular as a function of the positions of the orifices relative to the fuel injection systems mounted upstream of the chamber.

Advantageously, the number of primary air and dilution air inlet orifices in each wall of the chamber is equal to k times the number of said injection systems, where k is equal to 2, 3, or 4.

The primary air and dilution air inlet orifices preferably have a diameter lying in the range 5 millimeters (mm) to 20 mm, and more preferably in the range 10 mm to 15 mm.

The combustion chamber has a chamber end wall connecting together the upstream ends of its walls forming surfaces of revolution and including openings in which fuel injection systems and deflectors are mounted. The distance between the annular row of orifices in each wall and said deflector, as measured along the axis of the opening, is advantageously substantially equal to half the height of the primary combustion zone in the chamber so as to ensure that a flow of primary air and a flow of dilution air penetrates into the chamber through the above-mentioned orifices.

The above-mentioned injection systems may include means for feeding the air into the chamber using a fraction of the primary air flow that is to penetrate into the chamber, with the remainder of the primary air flow serving to pass through the orifices in each wall of the chamber, as described above.

The invention also provides a turbomachine, such as an airplane turboprop or turbojet, characterized in that it includes a combustion chamber as described above.

The invention can be better understood and other characteristics, details, and advantages of the present invention appear more clearly on reading the following description made by way of non-limiting example and with reference to the accompanying drawings, in which:

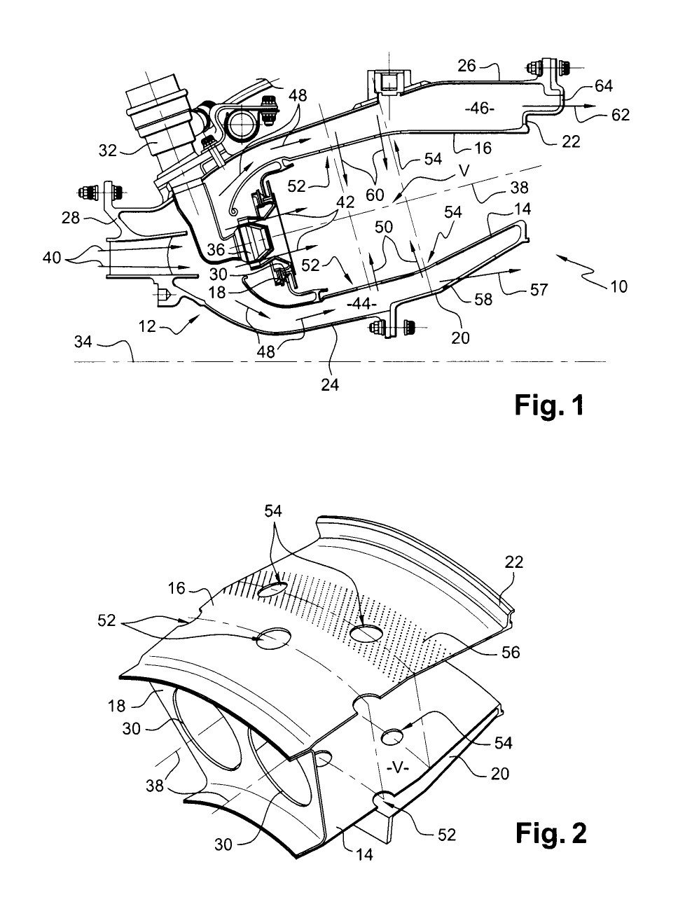

FIG. 1 is a diagrammatic half-view in axial section of a prior art turbomachine combustion chamber;

FIG. 2 is a fragmentary diagrammatic view in perspective of the walls of the FIG. 1 chamber;

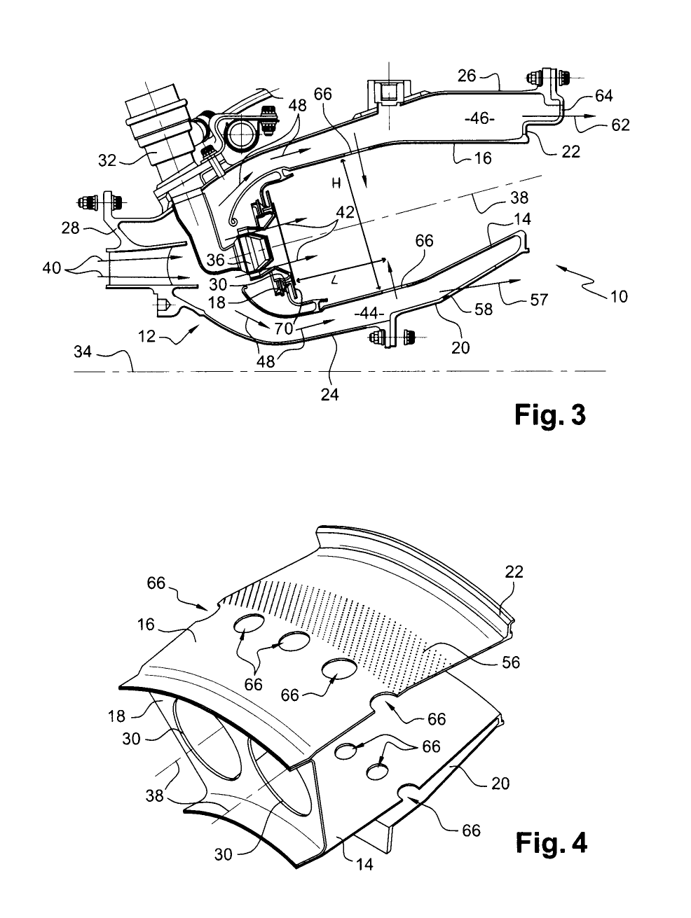

FIG. 3 is a diagrammatic half-view in axial section of a turbomachine combustion chamber of the invention;

FIG. 4 is a fragmentary diagrammatic view in perspective of the walls of the FIG. 3 chamber;

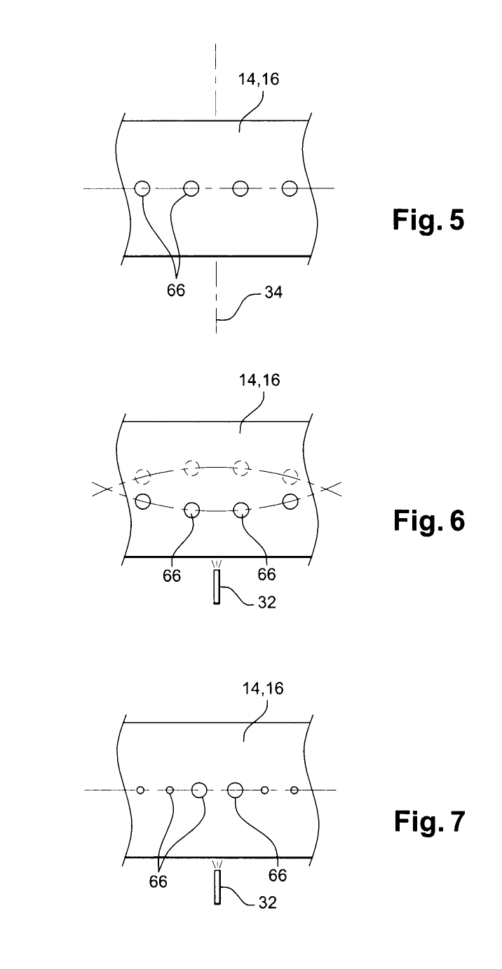

FIG. 5 is a highly diagrammatic fragmentary view of a cylindrical wall of a chamber of the invention, seen looking in a radial direction; and

FIGS. 6 and 7 are views corresponding to FIG. 5 and showing variant embodiments of a chamber wall of the invention.

Reference is made initially to FIG. 1, which shows an annular combustion chamber 10 for a turbomachine, which chamber is arranged at the outlet from a diffuser 12, itself situated at the outlet from a compressor (not shown), the chamber comprising an inner wall 14 forming a surface of revolution, and an outer wall 16 forming a surface of revolution, the inner and outer walls being connected together by an annular wall 18 forming a chamber end wall. The chamber walls 14 and 16 are fastened downstream via inner and outer annular flanges 20 and 22 respectively to an inner frustoconical shroud 24 of the diffuser and to one end of an outer casing 26 of the combustion chamber, the upstream end of the casing 26 being connected to an outer frustoconical shroud 28 of the diffuser.

The chamber end wall 18 has openings 30 (FIGS. 1 and 2) through which there passes air coming from the diffuser 12 and fuel delivered by injectors 32 fastened on the outer casing 26 and regularly distributed around a circumference about the longitudinal axis 34 of the chamber. Each injector 32 has a fuel injection head 36 mounted in an opening 30 of the annular wall 18 and in alignment with the axis 38 of the opening 30.

A fraction of the air flow delivered by the compressor and leaving the diffuser 12 (arrows 40) passes via the openings 30 and feeds the combustion chamber 10 (arrows 42), with the remainder of the air flow feeding inner and outer annular passages 44 and 46 bypassing the combustion chamber 10 (arrows 48).

The inner passage 44 is formed between the inner shroud 24 of the diffuser 12 and the inner wall 14 of the chamber, and the air that passes along this passage is shared between a flow 50 that penetrates into the chamber 10 via two rows of orifices 52, 54 in the inner wall 14, and a flow 57 that passes through holes 58 in the inner flange 20 of the chamber so as to proceed with cooling components (not shown) that are situated downstream from the chamber.

The outer passage 46 is formed between the outer casing 26 and the outer wall 16 of the chamber, and the air that passes along this passage is shared between a flow 60 that penetrates into the chamber 10 via two rows of orifices 52, 54 in the outer wall 16, and a flow 62 that passes through holes 64 in the outer flange 22 to proceed with cooling downstream components.

The two rows of orifices 52, 54 in each of the walls 14, 16 of the chamber are annular and spaced axially apart from each other, as can clearly be seen in FIGS. 1 and 2. The orifices 52 of the upstream annular row are primary air inlet orifices and they provide the chamber with a flow of air that ensures stoichiometric combustion of the fuel inside the chamber. The orifices 54 of the downstream annular row are dilution air inlet orifices for cooling the combustion gas to a temperature that is acceptable for the turbine of the turbomachine that is mounted downstream from the combustion chamber and that is not shown in the drawings.

In addition, the walls 14, 16 of the chamber include multiple perforations (not shown in FIG. 1 and represented diagrammatically at 56 in FIG. 2) serving to pass cooling air for cooling the walls.

The flow of cooling air passing through the primary air orifices 52 and the flow of air 42 passing through the injection system each represent 15% to 25% of the flow of air 40 delivered by the diffuser.

The flow of air passing via the dilution air orifices 54 is about 20% to 30%, and the flow of air passing via the multiple perforations 56 and via orifices for cooling the chamber end wall 18 is about 30% to 40% of the total air flow 40.

The invention serves to reduce significantly the emission of nitrogen oxides from an annular combustion chamber by eliminating the intermediate volume V that extends between the two annular rows of primary air orifices and of dilution air orifices. To do this, the downstream row of dilution air orifices is made to coincide with the upstream row of primary air orifices so as to form a single row of orifices that serve both for admitting primary air and for admitting dilution air.

In the embodiment of the invention shown in FIGS. 3 and 4, each wall 14, 16 of the chamber has only one annular row of primary air inlet orifices and of dilution air inlet orifices, these orifices being given the same reference 66 since each of them performs both functions of feeding the chamber with primary air and with dilution air.

The walls 14, 16 of the chamber also include multiple perforations 56 for passing air for cooling the walls.

The air flow passing via the orifices 66 represents about 25% to 50%, preferably 30% to 35%, e.g. 32% of the air flow 40 delivered by the diffuser. This air flow comprises a dilution air flow (approximately 20% to 30%) and a primary air flow (approximately 2% to 12%). The air flow 42 represents 30% to 40%, e.g. 38% (this flow including about 13% to 23% primary air), of the air flow 40, and the air flow for cooling the chamber end wall and the air that passes via the multiple perforations 56 represent about 30% of the total flow.

The air flow (25%-50%) passing through the orifices 66 is thus greater than the air flow (15%-25%) passing through the primary air orifices 52 of the prior art chamber, and the air flow 42 passing via the injection system (30%-40%) is likewise greater than the air flow 42 (15%-25%) of the prior art. The increase in the air flow passing through the injection system is favorable to decreasing nitrogen oxide emissions, and the increase in the air flow passing through the orifices 66 enables better control to be obtained over the temperature profile seen by the turbine at the outlet from the combustion chamber.

Furthermore, a fraction of the primary air flow (about ¼ of the total primary air flow) passes through the orifices 66 and serves to prevent recirculation zones occurring in the chamber, while the remainder of the primary air flow (thus representing ¾ of the total primary air flow) passes through the injection systems and serves to feed the chamber with air.

The axial position of the row of orifices 66 lies preferably between the axial positions of the rows of orifices 52 and 54 in the prior art. This makes it possible to compensate for the reduction in the relighting range of the chamber, due to the increase in the air flow contributing to combustion in the primary zone of the chamber.

In an embodiment of the invention, the axial position of the orifices 66 through each of the walls is such that the axial distance L between the axes of the orifices 66 and the deflectors 70 mounted in the openings 30 in the chamber end wall 18 (measured along the axis 38 of an opening 30), is substantially equal to half the height H of the primary combustion zone (FIG. 3), i.e. the distance between the inner and outer walls 14 and 16 of the chamber (measured in a plane perpendicular to the axis 38).

The orifices 66 may be identical in shape and/or dimensions or they may differ from one another. They may be of arbitrary shape: circular, oblong, etc. Their diameter lies in the range 5 mm to 20 mm, and preferably in the range 10 mm to 15 mm. In a particular embodiment of the invention, the orifices 66 in the outer wall have a diameter of about 14.5 mm and those in the inner wall have a diameter of about 12 mm.

The number of orifices 66 in each wall 14, 16 may be determined as a function of the number of injectors 32 fitted to the turbomachine. The number of orifices in each wall 14, 16 may, for example, be equal to k times the number of injectors, where k is equal to 2, 3, or 4.

Reference is made below to FIGS. 5 to 7 that show variant embodiments of the walls 14, 16 of the chamber of the invention.

The walls 14, 16 of FIG. 5 are similar to those of the embodiment of FIGS. 3 and 4, and they comprise an annular row of orifices 66 that are regularly distributed around a circumference centered on the longitudinal axis 34 of the chamber.

The orifices 66 are situated in a common plane that is substantially perpendicular to the axis 34 of the chamber and they are in alignment with one another on a substantially circular line. When the wall 14, 16 is observed in a radial direction (from the outside for the outer wall 16), this line is substantially straight and perpendicular to the axis 34 of the chamber.

In the variant embodiment of FIG. 6, the orifices 66 are situated on a curved line that forms a circular arc on the wall when the wall is observed in a radial direction. The orifices 66 drawn in continuous lines are situated on a curved line having its concave side directed downstream, and the orifice drawn in discontinuous lines are situated on a curved line having its concave side facing upstream. The line on which the orifices 66 are situated may form undulations in the wall, all around its periphery.

By way of example, the orifices 66 may be disposed in such a manner that the further upstream orifices (or the further downstream orifices) are aligned in an axial direction with the injectors 32.

The orifices 66 in the variant of FIG. 7 differ from those of FIG. 5 in that their diameters vary as a function of their positions relative to the injectors 32. The orifices 66 situated close to the injectors are greater in diameter than the other orifices in the example shown.

1-12. (canceled)

13. An annular combustion chamber for a turbomachine, an airplane turboprop, or turbojet, the chamber comprising:
coaxial walls forming surfaces of revolution that include inlet orifices for admitting primary air and inlet orifices for admitting dilution air into the chamber,
wherein the primary air inlet orifices and the dilution air inlet orifices in each wall are substantially in alignment with one another around the longitudinal axis of the chamber so as to form a single annular row of orifices.

14. A chamber according to claim 13, wherein the annular row of orifices in each wall is substantially circular.

15. A chamber according to claim 13, wherein the annular row of orifices in each wall is made up of circular arcs or undulations.

16. A chamber according to claim 13, wherein the walls of the chamber further include multiple perforations for passing cooling air.

17. A chamber according to claim 13, wherein a shape and/or dimensions of the orifices in each wall are substantially identical.

18. A chamber according to claim 13, wherein a shape and/or dimensions of the orifices in each wall differ from one another, as a function of positions of the orifices relative to fuel injection systems mounted upstream of the chamber.

19. A chamber according to claim 13, wherein the orifices have a diameter lying in a range of 5 mm to 20 mm, or in a range of 10 mm to 15 mm.

20. A chamber according to claim 13, wherein a number of orifices in each wall of the chamber is equal to k times a number of fuel injection systems mounted upstream of the chamber, where k is equal to 2, 3, or 4.

21. A chamber according to claim 13, wherein the orifices in each wall are regularly distributed around the longitudinal axis of the chamber.

22. A chamber according to claim 13, further comprising a chamber end wall connecting together upstream ends of the walls forming surfaces of revolution and including openings in which fuel injection systems and deflectors are mounted, a distance between the annular row of orifices and the deflector as measured along the axis of the opening being substantially equal to half the height of a primary combustion zone in the chamber.

23. A chamber according to claim 22, wherein the injection systems comprise means for feeding the chamber with air comprising a fraction of a primary air flow that is to penetrate into the chamber, a remainder of the primary air flow being arranged to pass through the orifices in each chamber wall.

24. A turbomachine, an airplane turboprop, or turbojet, comprising a combustion chamber according to claim 13.
